(19) United States
(12) Patent Application Publication
(10) Pub. No.: US 2005/0164590 A1
(43) Pub. Date: Jul. 28, 2005

(54) Process for the production of an electroluminescent flat capacitor arrangement, a lamp produced thereby and a light using such a lamp

(76) Inventor: Frank Gotthardt, Gottingen (DE)

Correspondence Address: The Bilicki Law Firm, P.C., 1285 North Main Street, Jamestown, NY, 14701, US

(21) Appl. No.: 11/044,932

(22) Filed: Jan. 27, 2005

(30) Foreign Application Priority Data
Jan. 28, 2004 (DE) 10 2004 004 311.6

(51) Int. Cl. H05B 33/10; H05B 33/14

(52) U.S. Cl. 445/24; 445/25

(57) ABSTRACT

In a process for the production of an electroluminescent flat capacitor arrangement, a transparent dielectric mixed with electroluminescent pigments is interposed between first and second moisture-impervious substrates each carrying a respective electrically conductive layer. The layer arrangement formed in that way is moisture-tightly encapsulated. At least one of the substrates and the electrically conductive layer carried thereby are transparent.

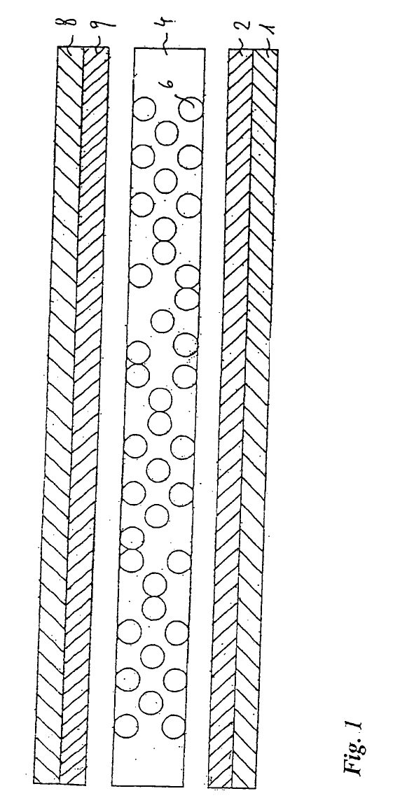

### CROSS-REFERENCES TO RELATED APPLICATIONS

The application claims the priority of German patent application Serial No 10 2004 004 311.6 of Jan. 28, 2004, the subject-matter of which is incorporated herein by reference.

### FIELD OF THE INVENTION

The invention concerns a process for the production of an electroluminescent flat capacitor arrangement, an electroluminescent lamp produced by such a process, and a light in which such a lamp is used.

### BACKGROUND OF THE INVENTION

In general terms a typical electroluminescent flat capacitor arrangement is produced by a procedure whereby a sequence of layers which cover each other over is applied to a flat side of a stiff or flexible carrier. The applied layers generally involve a base electrode, an insulating layer, a pigment layer, a cover electrode and a covering layer for protecting the overall assembly from moisture. If the carrier as such as not moisture-impervious, the covering layer must then also cover the other flat side of the carrier as well as the side edges of the overall assembly.

So that light produced in the interior of the flat capacity arrangement can issue, at least one of the two electrodes thereof must be formed by an electrically conductive, transparent layer. In the case of an arrangement in which light is intended to emanate from both main faces thereof, both the electrodes are transparent.

Even if the carrier is formed by a commercially available base material which is already provided with an electrically conductive layer by the manufacturer thereof, for example a plastic film coated on one side with copper or an ITO (indium tin oxide) coating, nonetheless a whole series of further process steps have to be performed in order to arrive at the desired electroluminescent flat capacitor arrangement. That procedure includes coating the base material with an insulating layer to which the pigment layer is applied in the next step, whereupon the coating operation is carried out with the generally transparent cover electrode which is formed by a suitable commercially available lacquer, particularly if the finished electroluminescent flat capacitor arrangement is to be flexible and/or embossable.

It will admittedly be accepted that all those coating steps can be carried out by means of suitable spray or printing processes, but what is common to all of them is that the substance which is initially applied in liquid form must dry or harden before the next coating step can be carried out, and that results in an increase in the length of the production time. In addition, a solvent which is used for applying a layer has to be compatible with the subjacent layer which is generally very thin, and it is not to cause it to dissolve to such a degree that flaws occur therein.

Thus, the foregoing processes are comparatively costly and time-consuming by virtue of the large number of individual production steps and the amount of time taken to implement same.

### SUMMARY OF THE INVENTION

An object of the present invention is to develop a process for the production of an electroluminescent flat capacitor arrangement such that it can be carried out with a markedly reduced number of steps and thus substantially faster.

A further object of the invention is to provide an electroluminescent flat capacitor arrangement production process involving a faster and more rational sequence of production steps thus making it more appropriate in particular for mass production of electroluminescent lamps and lights.

Still a further object of the invention is to provide a process for the production of electroluminescent flat capacitor arrangements, which can be carried out in a manner at least approaching a continuously operating procedure.

Yet another object of the present invention is to provide an electroluminescent flat capacitor arrangement which is of a simplified structure and which consequently can be produced by a more straightforward operating procedure.

In terms of the process the foregoing and other objects are attained by a process for the production of an electroluminescent flat capacitor arrangement, wherein provided between first and second moisture-impervious substrates each carrying a respective electrically conductive layer is a transparent dielectric mixed with electroluminescent pigments. The layer arrangement formed in that way is moisture-tightly encapsulated, at least one of the substrates and the electrically conductive layer carried by same being transparent.

In regard to the capacitor arrangement the foregoing and other objects are attained by an electroluminescent flat capacitor arrangement comprising first and second moisture-impervious substrates each having a first side and a second side, the first sides being in mutually facing relationship. A respective electrically conductive layer is disposed on each of the substrates on the first side thereof, while a transparent dielectric containing at least one electroluminescent pigment is disposed between the substrates. Moisture-tight encapsulation means encapsulate the layer arrangement consisting of the substrates with conductive layers and dielectric. At least one of the substrates and the electrically conductive layer carried thereby are transparent.

In accordance with the invention therefore, for the production of an electroluminescent flat capacitor arrangement, there are provided first and second substrates, for example films, each of which is covered at least on one side with an electrically conductive layer. Disposed between those two substrates is only one single further layer, namely a dielectric mixed with the electroluminescent pigments. The dielectric is assembled with the two substrates which face towards it with their electrically conductive coatings, to afford a sandwich unit. If the procedure uses commercially available substrates each provided with an electrically conductive layer and a dielectric layer mixed with pigments and embedded between two protective films which can be pulled off, then the process according to the invention is essentially reduced to a procedure such that, in a laminating operation which is implemented with continuous or endless material, the one protective film is continuously pulled off the dielectric layer, the latter is applied with its side which is free as a result to the electrically conductive layer of one of the two substrates, the second protective film is pulled off and the second of the two substrates is pressed with its electrically conductive layer against the top side, which is now free, of the dielectric layer.

If the substrates used are formed by flexible plastic films, the process can be implemented by a procedure whereby the specified components, namely the first and second substrate films each covered with an electrically conductive layer and the dielectric layer covered with the two protective films thereof are respectively drawn off an endless roll and passed through a suitable rolling or roller assembly in which the protective films are detached and the components are laminated together.

As in that procedure at most one of the components, namely the dielectric, contains a certain proportion of moisture or solvent which must evaporate off or diffuse out of the finished product, no waiting times are involved before a further process step can be implemented after a preceding step has been effected.

In a preferred feature, the dielectric is a transparent adhesive in which the pigments are embedded and which is capable of joining the substrates together by virtue of involving a firm adhesive join to the electrically conductive layers covering them. That adhesive layer therefore performs a triple function insofar as a) prior to being brought together with the substrates, it serves as a carrier for the pigments and in the assembled condition b) it serves on the one hand as a dielectric and c) it serves on the other hand as a joining layer which holds the assembly together and provides a moisture-tight sealing arrangement.

The adhesive system, in other words the nature of the adhesive and the thickness of the layer thereof, are to be matched to each other in such a way that the pigment or pigments is or are completely embedded in the adhesive matrix in order to guarantee adequate insulation between the two electrodes and to guarantee adhesive strength in respect of the substrates when laminated together. In addition the adhesive system is to be so selected that the energy losses due to the electrical displacement power when an ac voltage field is applied remain at a minimum and the electrical field is attenuated to the minimum possible extent in order to achieve an optimum light yield.

However even if commercially available substrates covered with electrically conductive layers are not used, but rather such substrates are produced in the context of the process of the invention in a first step, the process of the invention affords a considerable simplification in comparison with prior processes as the operation of coating the substrates with an electrically conductive material to form the electrically conductive layer can also be effected in a continuously operated process insofar as the electrically conductive material can be applied to a substrate web of suitable length by printing, spraying or sputtering thereon.

That process step can be carried out in a particularly advantageous manner if one and the same substrate material is used for the substrates of the electroluminescent flat capacitor arrangement. It is then possible to manufacture a single large web of material which is cut up into first and second web portions, with the electroluminescent layer structure then being produced in the continuous lamination procedure outlined above. In that case then both the substrates and both the electrically conductive layers are admittedly transparent so that in principle the result afforded is an electroluminescent lamp which emits light from both of the main faces thereof. If in contrast light is to be emitted only from one side of the electroluminescent lamp, one of the two main faces thereof can be covered with a layer consisting of a reflective material so that the light which tries to issue through that main face is reflected and is discharged through the opposite main face. That further cover layer can also be involved in influencing the color appearance of the electroluminescent lamp.

These and further advantageous configurations and developments of the process of the invention and the lamp and light according to the invention are set forth in appendant claims.

Further objects, features and advantages of the invention will be apparent from the description hereinafter of a preferred embodiment thereof.

### BRIEF DESCRIPTION OF THE DRAWING

The single FIGURE is a highly diagrammatic view in cross-section through components, which are not yet joined together, of an electroluminescent flat capacitor arrangement which can be produced by a process according to the invention.

### DESCRIPTION OF THE PREFERRED EMBODIMENT

When the description hereinafter uses expressions such as ‘down’, ‘up’ and the like, that relates only to the FIGURE of the drawing and not to a fixed spatial arrangement in respect of the individual components of the arrangement in carrying out the process according to the invention. It will further be appreciated that the individual layer thicknesses in the arrangement are shown on a greatly enlarged scale for the sake of clarity and are also not in strict proportion with each other.

Referring therefore now to the FIGURE, shown therein is a first moisture-tight substrate 1 which on its top side in the FIGURE carries an electrically conductive layer 2.

Disposed above the first substrate 1 at a spacing therefrom is a second moisture-tight substrate 8 which on its underside carries an electrically conductive layer 9.

Shown between the first and second substrates 1 and 8 is a dielectric layer 4 in which at least one electroluminescent pigment 6 and preferably a plurality thereof is or are embedded.

As illustrated the dielectric layer 4 can consist of a single layer in which the pigments 6 are more or less uniformly distributed.

As an alternative thereto however it is also possible for the dielectric to be of a multi-layer configuration and in particular to consist of first, second and third layers, in such a way that an upper and a lower edge layer contain no or substantially fewer pigments 6 which are then provided completely or substantially only in a central layer disposed between those edge layers. That can be advantageous for the purposes of improving dielectric strength and/or, if the dielectric is in the form of an adhesive joining the substrates 1, 8 together, for the purposes of enhancing the adhesive forces involved.

In the finished assembled condition the electrically conductive layers 2 and 9 respectively bear directly against the surfaces of the interposed dielectric layer 4 in such a way as to afford a compact layer structure in the form of a flat capacitor in which the two electrically conductive layers 2 and 9 form the electrodes of the capacitor. If an ac voltage of the order of magnitude of between about 100 and 150 V is applied to those electrodes, the doped electroluminescent pigments 6 give off a light which, depending on the respective nature of the substrates 1 and 8 and the electrically conductive layers 2 and 9 applied thereto, is emitted either upwardly, downwardly or both upwardly and also downwardly.

For light emission only in one direction, for example upwardly, the lower substrate 1 and/or the electrically conductive layer 2 applied thereto can comprise a non-transparent material. More particularly, the electrically conductive layer 2 can be a copper layer. Both the upper substrate 8 and also the electrically conductive layer 9 applied to the underside thereof must then be transparent in relation to the light given off by the pigments 6.

If the electroluminescent light arrangement is to be of such a nature that the light thereof is given off towards both sides, that is to say both upwardly and also downwardly in the FIGURE, then the two substrates 1 and 8 as well as the electrically conductive layers 2 and 9 respectively applied thereto each comprise a transparent material, preferably being the same material.

However, even if light issue is wanted at only one side, it is preferable for the substrates 1 and 8 and the electrically conductive layers 2 and 9 disposed thereon to be made from the same transparent materials. One of the flat sides of the electroluminescent light arrangement is then covered by an opaque layer which is not shown in the FIGURE and which can advantageously be in the form of a reflector so that the light impinging thereon is reflected through the electroluminescent light arrangement in such a way that it emanates on the opposite side in order to achieve an enhanced light yield.

A particular advantage of the above-outlined procedure is that the two substrates 1 and 8 with their electrically conductive layers 2, 9 can be produced jointly as a unitary web of material which is then cut into the two film portions required.

The dielectric 4 with the electroluminescent pigments 6 homogeneously distributed therein can be interposed in different ways between the mutually facing electrically conductive layers 2 and 9 on the substrates 1 and 8.

A preferred procedure here is a transfer process in which the dielectric 4 with the embedded pigments 6 is produced in a preceding step of the process in the form of a layer of uniform thickness which is enclosed in a sandwich structure between first and second cover films comprising a suitable material, for example waxed paper.

Then, to produce the electroluminescent light arrangement, one of those films consisting for example of waxed paper is pulled off and the dielectric 4, with its exposed surface, is pressed for example against the electrically conductive layer 2 of the lower substrate 1. At the same time or shortly thereafter the second film consisting for example of waxed paper can also be pulled off and the substrate 8 with its electrically conductive layer 9 can be pressed from above against the dielectric 8.

As an alternative thereto it is also possible for the dielectric 4 with the embedded pigments 6 to be applied to the side, which is covered by the electrically conductive layer, of one of the two substrates, by any other coating process, for example by an offset, rolling, screen printing or other printing process, in order then to laminate the other substrate thereover.

It is particularly advantageous if the dielectric 4 serves at the same time for joining the two substrates 1 and 8 together in flat relationship with each other.

For that purpose it is possible to use as the dielectric an adhesive which adheres directly to the two electrically conductive layers 2 and 9 after it has been firmly joined thereto for example by a lamination or rolling operation, to which the sandwich assembly initially formed from the substrates 1 and 8 and the interposed adhesive layer 4 is subjected. Preferably in that respect the adhesive used is one which, after it has hardened, forms a moisture-impermeable layer and which thus protects the sensitive pigments 6 distributed therein.

Instead of an adhesive layer it is also possible to use another transparent dielectric 4, for example a polymer, in which the pigments 6 are embedded and which, after it has been introduced between the substrates 1 and 8 or the electrically conductive layers 2 and 9 thereon, is caused to harden by UV irradiation and thus firmly joins the substrates 1 and 8 together and at the same time provides for a moisture-tight encapsulation effect.

The dielectric 4 in which the pigments 6 are embedded does not necessarily have to firmly join together the two substrates 1 and 8 with their electrically conductive layers 2 and 9. It is sufficient if it is arranged immovably between the substrates 1 and 8. They are then moisture-tightly joined together at their edges, for example by welding, in order to protect the moisture-sensitive pigments 6 from the ingress of water vapor or moisture.

Optical elements can be arranged on the outside of the substrate 1 and/or the substrate 8, through which the light given off by the pigments 6 is intended to issue. The optical elements can provide for example for a specific form of distribution of light in such a way that they reduce the irradiation angle and afford an enhanced level of light intensity in the remaining light emission angle. Those optically effective elements can be applied directly to the outside surface of the respective substrate 1 and 8 in question, for example they can also be fixed in position by means of a transparent adhesive, or they can be fitted in place in front thereof and held in position as separate elements, in the frame of a light.

Both the electrically conductive layers 2 and 9 and also the dielectric 4 with the pigments 6 embedded therein can be applied to the respective substrate 1 and 8 respectively or introduced between those substrates, over the entire surface area involved.

As an alternative thereto however it is also possible for one or both electrically conductive layers 2 and 9 and/or the dielectric 4 to be applied only to selected surface regions of the substrates 1 and 8 if for example characters or symbols or the like which light up are to be represented by the arrangement. In that case the components are preferably applied by means of a printing process such as screen printing, offset printing or roller printing, before the substrates 1 and 9 are joined together.

A particularly preferred process according to the invention involves a procedure whereby firstly a transparent, electrically conductive layer is applied on one side to a web of starting material formed by a transparent, moisture-tight plastic film, either by a printing or spraying process or by sputtering thereon. The transparent electrically conductive layer comprises for example a transparent, electrically conductive lacquer or an ITO layer.

The above-mentioned web of starting material which can be produced continuously or so-to-speak endlessly is then cut up into first and second webs of film portions constituting the respective substrates 1 and 8, wherein one thereof is so turned and positioned that the electrically conductive layer thereof is disposed in precisely opposite relationship to the electrically conductive layer of the other web of film portion. Then, the separately prepared dielectric layer with the electroluminescent pigments homogeneously distributed therein is introduced between those two webs of film portions, for example by means of the above-mentioned transfer process, and the overall layer arrangement is then laminated together to form a composite structure, wherein preferably the dielectric also provides at the same time for a moisture-tight encapsulation effect.

Then, as required, individual electroluminescent lamp components are cut out of the resulting endless web and contacted for example by means of conventional crimp elements which can be pressed through the films on to the conductor tracks. As an alternative it is also possible to produce on the upper and lower films stamped-out openings through which the electrically conductive layers can be contacted.

The transparency of the electroluminescent lamp produced by the process of the invention can be varied by virtue of the proportion of pigment in the dielectric layer as the electroluminescent pigments as such are not transparent.

Instead of plastic films it is also possible to use other materials, in particular materials which are stiffer or less flexible, as the substrates. It is also possible to adopt a combination such that one of the substrates is formed by a stiff or less flexible material and the other is formed by a flexible plastic film which is thus easier to process.

It will be appreciated that the above-described process, flat capacitor arrangement, lamp and light according to the invention have been set forth solely by way of example and illustration of the principles of the invention and that various other modifications and alterations may be made therein without thereby departing from the spirit and scope of the invention.

1. A process for the production of an electroluminescent flat capacitor arrangement comprising
providing first and second moisture-impervious substrates,
providing a respective electrically conductive layer on each of the substrates,
interposing a transparent dielectric containing at least one electroluminescent pigment between the substrates,
wherein the substrates with conductive layers and dielectric form a layer arrangement and wherein at least one of the substrates and the electrically conductive layer carried thereby are transparent, and
moisture-tightly encapsulating said layer arrangement.

2. A process as set forth in claim 1
wherein the transparent dielectric also serves to join the first and second substrates together in moisture-tight relationship.

3. A process as set forth in claim 1
wherein the transparent dielectric is firstly applied to the side of the first substrate which carries the respective electrically conductive layer, thereby forming a layer structure, and
the second substrate is applied by lamination to the layer structure in such a way that its electrically conductive layer is towards the transparent dielectric.

4. A process as set forth in claim 3
wherein the dielectric is applied over the full surface area by means of one of a transfer procedure and a coating procedure.

5. A process as set forth in claim 3
wherein the dielectric is applied only to selected surface regions by means of a printing procedure, and
moisture-tight encapsulation is effected by welding of the edges of the substrates.

6. A process as set forth in claim 1
wherein the transparent dielectric mixed with at least one electroluminescent pigment is an adhesive which adheres firmly directly to the sides of the substrates, which sides face towards the dielectric and carry the respective electrically conductive layer thereon.

7. A process as set forth in claim 1
wherein the transparent dielectric mixed with at least one electroluminescent pigment is a polymer which is hardened after introduction between the substrates each carrying a respective electrically conductive layer thereby firmly and moisture-tightly joining the first and second substrates together.

8. A process as set forth in claim 1
wherein the transparent dielectric includes first, second and third layers, the first and third layers being edge layers which in the finished condition of the electroluminescent flat capacitor arrangement bear directly against the electrically conductive layers of the first and second substrates and without electroluminescent pigment, and a central layer containing electroluminescent pigment.

9. A process as set forth in claim 1
wherein both the first and second substrates and also the electrically conductive layers thereon respectively comprise the same material.

10. A process as set forth in claim 9
wherein the first and second substrates are produced from the same starting material web carrying an electrically conductive layer.

11. A process as set forth in claim 1
wherein the respective electrically conductive layer is applied to the respective substrate by one of a sputtering and a printing procedure.

12. A process as set forth in claim 11
wherein the respective electrically conductive layer is applied to the respective substrate over the entire surface thereof.

13. A process as set forth in claim 11
wherein the respective electrically conductive layer is applied to the respective substrate only in selected surface regions thereof.

14. A process as set forth in claim 1
which is in the form of a continuously operated process.

15. A process as set forth in claim 1
wherein the substrates are flexible films.

16. A process as set forth in claim 15
wherein the films are drawn off rolls and after finishing are cut into individual electroluminescent flat capacitor arrangements.

17. A process as set forth in claim 15
wherein one of said films is provided with a reflection layer on a flat side of the film which is in opposite relationship to the respective electrically conductive layer.

18. A process as set forth in claim 15
wherein at least one of the films is provided with at least one optically effective element on a flat side of the film which is in opposite relationship to the respective electrically conductive layer.

19. An electroluminescent flat capacitor arrangement produced by a process as set forth in claim 1.
